(19) United States
(12) Patent Application Publication
(10) Pub. No.: US 2015/0118608 A1
(43) Pub. Date: Apr. 30, 2015

(54) MULTI-LAYER ELECTROPHOTOGRAPHIC PHOTOSENSITIVE MEMBER

(71) Applicant: KYOCERA Document Solutions Inc., Osaka (JP)

(72) Inventors: Jun AZUMA, Osaka (JP); Hideki OKADA, Osaka (JP)

(73) Assignee: KYOCERA Document Solutions Inc., Osaka (JP)

(21) Appl. No.: 14/522,035

(22) Filed: Oct. 23, 2014

(30) Foreign Application Priority Data
Oct. 30, 2013 (JP) 2013-225107

(51) Int. Cl. G03G 5/06

(52) U.S. Cl. CPC G03G 5/0618; G03G 5/0614; G03G 5/0609
USPC 430/58.25; 430/58.85

(57) ABSTRACT

A multi-layer electrophotographic photosensitive member contains a charge generating material including oxo-titanium phthalocyanine that among diffraction peaks for Bragg angles 2θ±0.2° with respect to characteristic X-rays of CuKα having a wavelength of 1.542 Å, at least exhibits a highest diffraction peak at 27.2°. The multi-layer electrophotographic photosensitive member also contains a hole transport material including a triarylamine derivative shown in Generic Formula (1). A ratio of the hole transport material relative to a binder resin in a charge transport layer is no greater than 0.55. In Generic Formula (1), Ar₁ represents an aryl group substituted with at least one substituent selected from the group consisting of an alkoxy group having two to four carbon atoms and an optionally substituted phenoxy group, and Ar₂ represents an aryl group optionally substituted with an alkyl group having one to four carbon atoms.

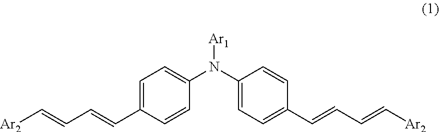

### INCORPORATION BY REFERENCE

The present application claims priority under 35 U.S.C. §119 to Japanese Patent Application No. 2013-225107, filed Oct. 30, 2013. The contents of this application are incorporated herein by reference in their entirety.

### BACKGROUND

The present disclosure relates to a multi-layer electrophotographic photosensitive member.

An electrophotographic photosensitive member is used as an image bearing member in an electrophotographic printer or multifunction peripheral. The electrophotographic photosensitive member typically includes a conductive substrate and a photosensitive layer located above the conductive substrate, either directly on the conductive substrate or separated therefrom. An electrophotographic photosensitive member in which the photosensitive layer contains a charge generating material, a charge transport material, and an organic material such as a binder resin that binds the aforementioned materials, is referred to as an electrophotographic organic photosensitive member. In a configuration in which the charge transport material and the charge generating material are contained in separate layers, the electrophotographic organic photosensitive member is referred to as a multi-layer photosensitive member. On the other hand, in a configuration in which the charge transport material and the charge generating material are contained in the same layer, and thus in which functions of charge generation and charge transport are implemented by the same layer, the electrophotographic organic photosensitive member is referred to as a single-layer photosensitive member.

Another example of a photosensitive member is an electrophotographic inorganic photosensitive member in which an inorganic material is used, such as a selenium photosensitive member or an amorphous silicon photosensitive member. Compared to electrophotographic inorganic photosensitive members, electrophotographic organic photosensitive members tend to be advantageous in terms of ease of film formation, ease of manufacture, and relatively small impact of the environment. Therefore, at present it is common for an image forming apparatus to include an electrophotographic organic photosensitive member.

An example of a hole transport material for transporting holes that is suitable for use as a charge transport material in a single- or multi-layer organic photosensitive member is a butadienylbenzene amine derivative. The butadienylbenzene amine derivative is a suitable material having excellent hole transportation characteristics.

### SUMMARY

A multi-layer electrophotographic photosensitive member relating to the present disclosure includes a photosensitive layer. The photosensitive layer includes, as sub-layers thereof, a charge generating layer containing a charge generating material, and a charge transport layer containing a hole transport material and a binder resin. The charge generating material includes oxo-titanium phthalocyanine that among diffraction peaks for Bragg angles 2θ±0.2° with respect to characteristic X-rays of CuKα having a wavelength of 1.542 Å, at least exhibits a highest diffraction peak at 27.2°. In the charge transport layer, a ratio of the hole transport material relative to the binder resin is no greater than 0.55. The hole transport material includes a triarylamine derivative shown in Generic Formula (1).

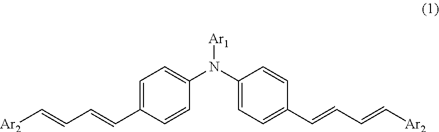

In Generic Formula (1), Ar₁ represents an aryl group substituted with at least one substituent selected from the group consisting of an alkoxy group having two to four carbon atoms and an optionally substituted phenoxy group, and Ar₂ represents an aryl group optionally substituted with an alkyl group having one to four carbon atoms.

### BRIEF DESCRIPTION OF THE DRAWINGS

FIGS. 1A, 1B, and 1C are schematic cross-sectional diagrams each illustrating structure of a multi-layer electrophotographic photosensitive member according to an embodiment of the present disclosure.

### DETAILED DESCRIPTION

The following explains a multi-layer electrophotographic photosensitive element according to an embodiment of the present disclosure with reference to the attached drawings. However, the present disclosure is in no way limited to the embodiment.

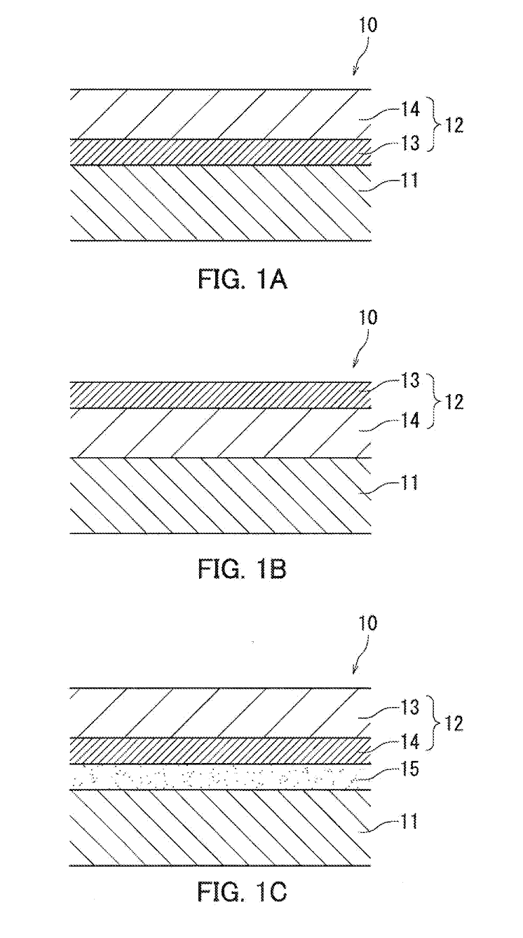

FIGS. 1A, 1B, and 1C are schematic cross-sectional diagrams each illustrating structure of a multi-layer electrophotographic photosensitive member 10 according to the embodiment.

(1) Basic Configuration

As illustrated in FIG. 1A, the multi-layer electrophotographic photosensitive member (herein also referred to simply as an electrophotographic photosensitive member or a photosensitive member) 10 includes a conductive substrate 11 and a photosensitive layer 12. The photosensitive layer 12 includes a charge generating layer 13 and a charge transport layer 14 as sub-layers thereof. In the multi-layer electrophotographic photosensitive member 10 illustrated in FIG. 1A, the charge generating layer 13 is located on the conductive substrate 11 and the charge transport layer 14 is located on the charge generating layer 13.

The multi-layer electrophotographic photosensitive member 10 can be manufactured by layering the charge generating layer 13 and the charge transport layer 14 on the conductive substrate 11 through an application method or the like. The charge generating layer 13 contains a charge generating material. The charge transport layer 14 contains a hole transport material as a charge transport material.

As illustrated in FIG. 1B, in the multi-layer electrophotographic photosensitive member 10, alternatively the charge transport layer 14 may be located on the conductive substrate 11 and the charge generating layer 13 may be located on the charge transport layer 14. However, when the multi-layer electrophotographic photosensitive member 10 has the structure illustrated in FIG. 1B, the charge transport layer 14 typically has a greater film thickness than the charge generating layer 13, and thus the charge transport layer 14 is typically more resistant to damage than the charge generating layer 13. Therefore, the multi-layer electrophotographic photosensitive member 10 preferably has a structure such as illustrated in FIG. 1A, in which the charge transport layer 14 is located on the charge generating layer 13.

Also, preferably the multi-layer electrophotographic photosensitive member 10 has a structure such as illustrated in FIG. 1C, in which an intermediate layer 15 is located between the conductive substrate 11 and the photosensitive layer 12.

Although it is normally preferable for the charge transport layer 14 to only contain a hole transport material, the charge transport layer 14 may alternatively contain both a hole transport material and an electron transport material.

(2) Conductive Substrate 11

The conductive substrate 11 illustrated in FIGS. 1A, 1B, and 1C can be made from various conductive materials. Examples of the conductive substrate 11 include conductive substrates made from metals (for example, iron, aluminum, copper, tin, platinum, silver, vanadium, molybdenum, chromium, cadmium, titanium, nickel, palladium, indium, stainless steel, and brass), conductive substrates made from a plastic material having any of the aforementioned metals laminated or vapor deposited thereon, and conductive substrates made from glass covered by aluminum iodide, alumite, tin oxide, indium oxide, or the like.

Either the whole of the conductive substrate 11 is conductive or at least the surface of the conductive substrate 11 is conductive. The conductive substrate 11 preferably has mechanical strength sufficient for use thereof. The shape of the conductive substrate 11 is determined so as to match the structure of an image forming apparatus in which the conductive substrate 11 is used. For example, the conductive substrate 11 may be shaped as a sheet or a drum.

(3) Intermediate Layer 15

As illustrated in FIG. 1C, the multi-layer electrophotographic photosensitive member 10 may include the intermediate layer 15 that is located on the conductive substrate 11 and that contains a specified binder resin for use in the intermediate layer 15.

Inclusion of the intermediate layer 15 in the multi-layer electrophotographic photosensitive member 10 can improve adhesion between the conductive substrate 11 and the photosensitive layer 12. Furthermore, by including a specified fine power in the intermediate layer 15 as an additive, it is possible to restrict occurrence of interference stripes through scattering of incident light and also to restrict charge injection into the photosensitive layer 12 from the conductive substrate 11 when the photosensitive layer 12 is not exposed to light. Such charge injection is a major cause of fogging and black spots. Examples of materials that can be used as the fine powder include white pigments (for example, titanium oxide, zinc oxide, zinc white, zinc sulfide, white lead, and lithopone), inorganic pigments used as extender pigments (for example, alumina, calcium carbonate, and barium sulfate), fluororesin particles, benzoguanamine resin particles, and styrene resin particles. However, there is no particular limitation on the fine powder, so long as the fine powder has light scattering and dispersion properties. The intermediate layer 15 preferably has a film thickness of at least 0.1 μm and no greater than 50 μm.

(4) Charge Generating Layer 13

The charge generating layer 13 of the multi-layer electrophotographic photosensitive member 10 contains oxo-titanium phthalocyanine as a charge generating material. Among diffraction peaks for Bragg angles 2θ)(±0.2° with respect to characteristic X-rays (wavelength 1.542 Å) of CuKα, the oxo-titanium phthalocyanine at least exhibits a highest diffraction peak at 27.2°. During differential scanning calorimetry, the oxo-titanium phthalocyanine exhibits one peak, other than a peak accompanying vaporization of absorbed water, in a range from 270° C. to 400°. Efficiency of charge generation can be improved by using the oxo-titanium phthalocyanine described above, due to crystal form transition of oxo-titanium phthalocyanine crystals from Y to α or from Y to β being restricted in an organic solvent contained in an application liquid for preparing the charge generating layer 13.

The charge generating layer 13 may additionally contain at least one selected from the group consisting of metal-free phthalocyanine (t-type or X-type), hydroxygallium phthalocyanine (V-type), and chlorogallium phthalocyanine (II-type) as the charge generating material.

The amount of the charge generating material contained in the charge generating layer 13 is preferably at least 5 parts by mass and no greater than 1,000 parts by mass relative to 100 parts by mass of the binder resin (base resin) contained in the charge generating layer 13. The base resin contained in the charge generating layer 13 is for example a bisphenol A type resin, a bisphenol Z type resin, or a bisphenol C type resin. Examples of the aforementioned resins include polycarbonate resins, polyester resins, methacrylic resins, acrylic resins, polyvinyl chloride resins, polystyrene resins, polyvinyl acetate resins, styrene-butadiene copolymer resins, vinylidene chloride-acrylonitrile copolymer resins, vinyl chloride-vinyl acetate-maleic anhydride resins, silicone resins, silicone-alkyd resins, phenol-formaldehyde resins, styrene-alkyd resins, and N-vinyl-carbazoles. Note that the resins listed above may be used singly or in a combination of two or more types. The charge generating layer 13 preferably has a film thickness of at least 0.1 μm and no greater than 5 μm.

(5) Charge Transport Layer 14

In the multi-layer electrophotographic photosensitive member 10, the hole transport material contained in the charge transport layer 14 is a triarylamine derivative shown in Generic Formula (1).

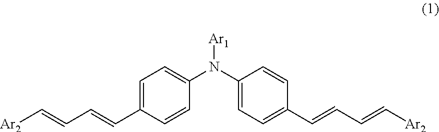

In Generic Formula (1), Ar₁ represents an aryl group substituted with at least one substituent selected from the group consisting of an alkoxy group having two to four carbon atoms and an optionally substituted phenoxy group, and Ar₂ represents an aryl group optionally substituted with an alkyl group having one to four carbon atoms. By using, as the hole transport material, the triarylamine derivative shown in Generic Formula (1) which includes an alkoxy group having a specified number of carbon atoms or a phenoxy group in the arylamine group, crystallization can be restricted while also effectively contributing to electrical characteristics, including in particular restriction of residual potential.

The effects described above that are achieved through use of the triarylamine derivative shown in Generic Formula (1) are thought to arise for the following reasons.

Firstly, coating solvent solubility can be improved due to the alkoxy group having a specified number of carbon atoms or the phenoxy group being present in the arylamine group of the triarylamine derivative shown in Generic Formula (1). As a result, crystallization and insufficient dispersion in the photosensitive layer during film formation can be effectively restricted.

Also, the ionization potential can be reduced due to the alkoxy group having a specified number of carbon atoms or the phenoxy group being present in the arylamine group of the triarylamine derivative shown in Generic Formula (1). As a result, the energy gap for charge transfer between the triarylamine derivative shown in Generic Formula (1) and the charge generating material (or another material) can be reduced, and thus charge transport efficiency can be effectively improved. In particular, in a multi-layer electrophotographic photosensitive member in which the charge generating layer and the charge transport layer are separate layers, using the triarylamine derivative shown in Generic Formula (1) as the hole transport material in the charge transport layer can effectively improve charge migration at an interface between the charge generating layer and the charge transport layer. Therefore, presence of the alkoxy group having a specified number of carbon atoms or the phenoxy group in the arylamine group of the triarylamine derivative shown in Generic Formula (1) enables excellent electrical characteristics for an electrophotographic photosensitive member.

Examples of the aryl group represented by Ar₁ in Generic Formula (1) include aryl groups having 6 to 12 carbon atoms, and more specifically include a phenyl group, a tolyl group, a xylyl group, a mesityl group, a naphthyl group, anthryl group, and a phenanthryl group. Among the groups listed above, the aryl group represented by Ar₁ is preferably the phenyl group.

The aryl group represented by Ar₁ in Generic Formula (1) has at least one substituent (preferably one or two substituents). Examples of the substituent of the aryl group include an alkoxy groups having two to four carbon atoms and an optionally substituted phenoxy group. Specific examples of the alkoxy group having two to four carbon atoms include an ethoxy group, a 1-propoxy group, a 2-propoxy group, an n-butoxy group, an iso-butoxy group, and a tert-butoxy group. Among the groups listed above, the alkoxy group having two to four carbon atoms is preferably the ethoxy group, the 2-propoxy group, or the n-butoxy group. The substituent of the optionally substituted phenoxy group is for example an alkyl group having one to four carbon atoms, and more specifically is for example a methyl group, an ethyl group, an n-propyl group, an iso-propyl group, an n-butyl group, an iso-butyl group, or a tert-butyl group. Among the groups listed above, the substituent of the optionally substituted phenoxy group is preferably the methyl group.

Each of the aryl groups represented by Ar₂ in Generic Formula (1) is for example any of the groups listed above as examples of the aryl group represented by Ar₁ in Generic Formula (1), and is preferably a phenyl group. The aforementioned aryl group may include, as a substituent, an alkyl group having one to four carbon atoms. Examples of the aforementioned substituent, which is an alkyl group having one to four carbon atoms, include a methyl group, an ethyl group, an n-propyl group, an iso-propyl group, an n-butyl group, an iso-butyl group, and a tert-butyl group. Among the groups listed above, the substituent is preferably the methyl group.

The amount of the triarylamine derivative shown in Generic Formula (1) is preferably no greater than 55 parts by mass relative to 100 parts by mass of the binder resin contained in the charge transport layer 14. The reason for the above is that dispersibility in the charge transport layer 14 of the triarylamine derivative shown in Generic Formula (1) can be improved through the amount of the triarylamine derivative shown in Generic Formula (1) being within the aforementioned range. Through the above, excellent characteristics in terms of electrical sensitivity can be achieved. If the amount of the triarylamine derivative shown in Generic Formula (1) exceeds 55 parts by mass, dispersibility in the charge transport layer may be reduced, crystallization tendency may be increased, and charge transport efficiency may be reduced.

HTM-1 to HTM-9 shown in Formulae (1-1) to (1-9) are provided as examples of the triarylamine derivative shown in Generic Formula (1).

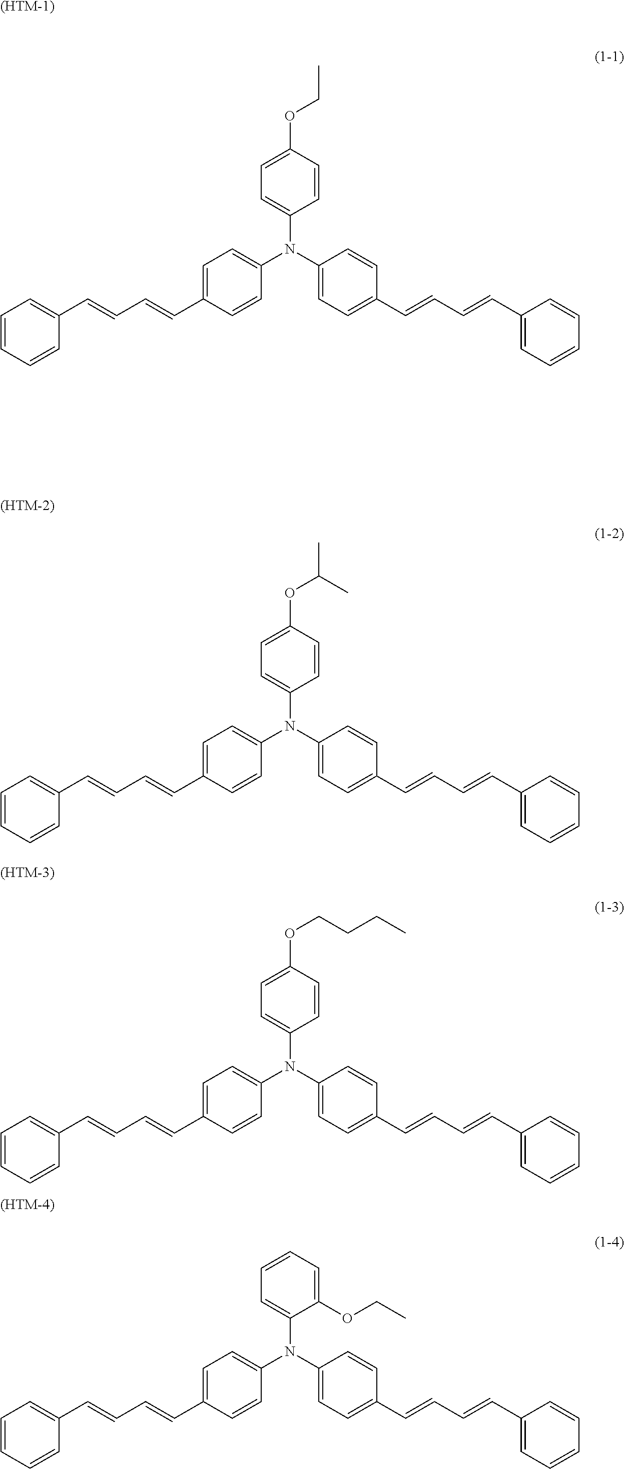

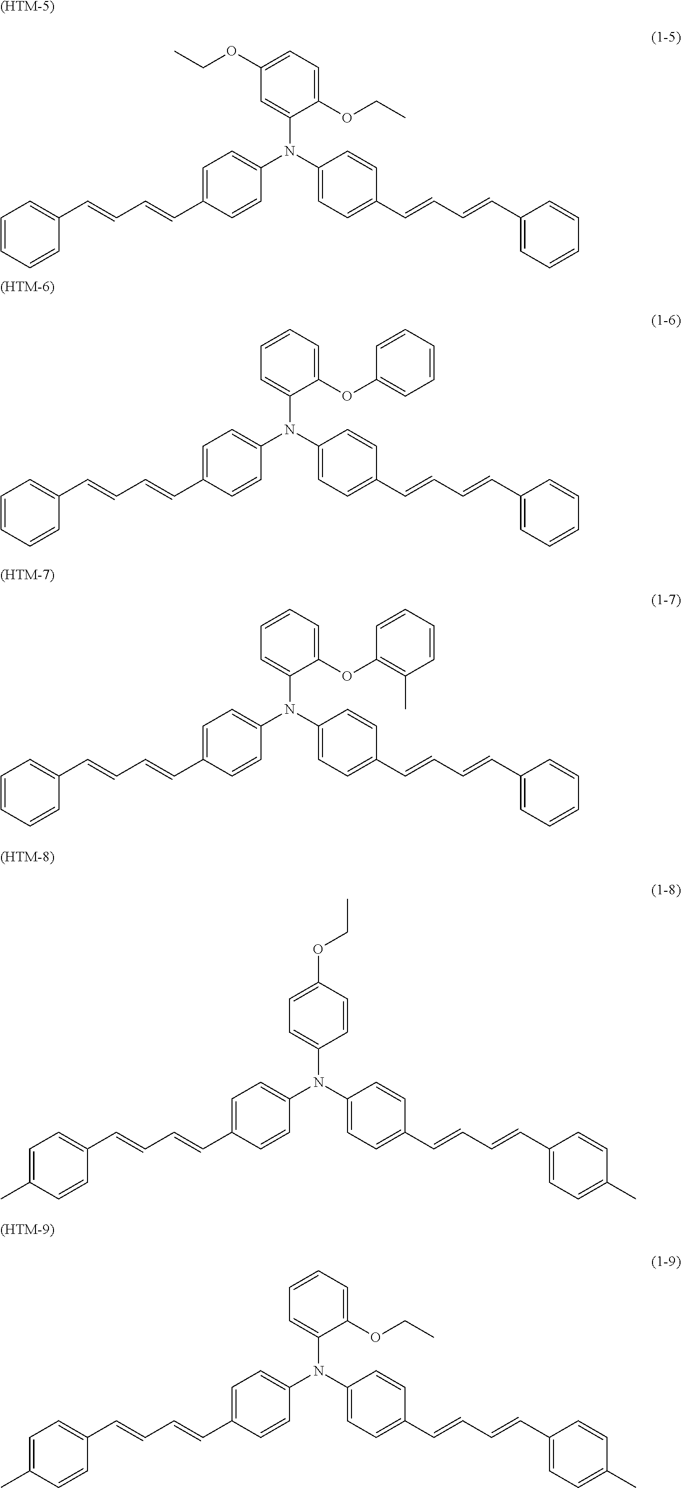

The charge transport layer 14 may further contain a different hole transport material in addition to the triarylamine derivative shown in Generic Formula (1). Examples of the aforementioned hole transport material include nitrogen-containing cyclic compounds and condensed polycyclic compounds. Specific examples of the nitrogen-containing cyclic compounds and the condensed polycyclic compounds include triarylamine derivatives other than the triarylamine derivative shown in Generic Formula (1) (for example, triphenyl amine-based compounds), oxadiazole-based compounds (for example, 2,5-di(4-methylaminophenyl)-1,3,4-oxadiazole), styryl-based compounds (for example, 9-(4-diethylaminostyryl)anthracene), carbazole-based compounds (for example, polyvinyl carbazole), organic polysilane compounds, pyrazoline-based compound (for example, 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds. Note that the different hole transport materials listed above may be used singly or in a combination of two or more types.

When, as described above, the charge transport layer 14 further includes the different hole transport material in addition to the triarylamine derivative shown in Generic Formula (1), the amount of the different hole transport material is preferably at least 1 part by mass and no greater than 100 parts by mass relative to 100 parts by mass of the triarylamine derivative shown in Generic Formula (1).

Furthermore, the binder resin contained in the charge transport layer 14 preferably includes at least one of a polycarbonate resin having a repeating unit shown in Generic Formula (2a) and a polycarbonate resin having a repeating unit shown in Generic Formula (2b).

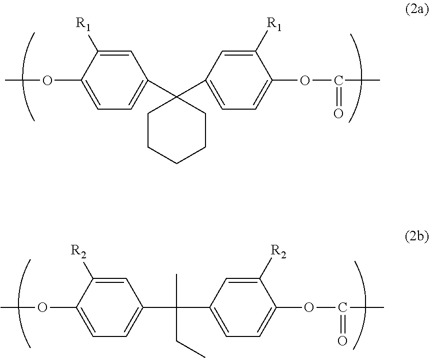

R₁ in Generic Formula (2a) represents a methyl group or a hydrogen atom. R₂ in Generic Formula (2b) represents a methyl group or a hydrogen atom.

Resin-1, Resin-2, and Resin-3 having repeating units shown below in Formulae (2a-1), (2a-2), and (2b-1) respectively, are provided as specific examples of the polycarbonate resin having the repeating unit shown in Generic Formulae (2a) and the polycarbonate resin having the repeating unit shown in Generic Formulae (2b).

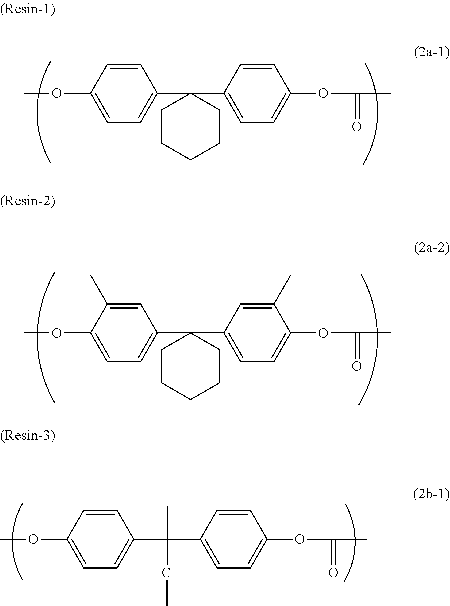

Alternatively, the binder resin contained in the charge transport layer 14 preferably includes at least one of a polyarylate resin having a repeating unit shown in Generic Formula (2c) and a polyarylate resin having repeating units shown in Generic Formula (2d).

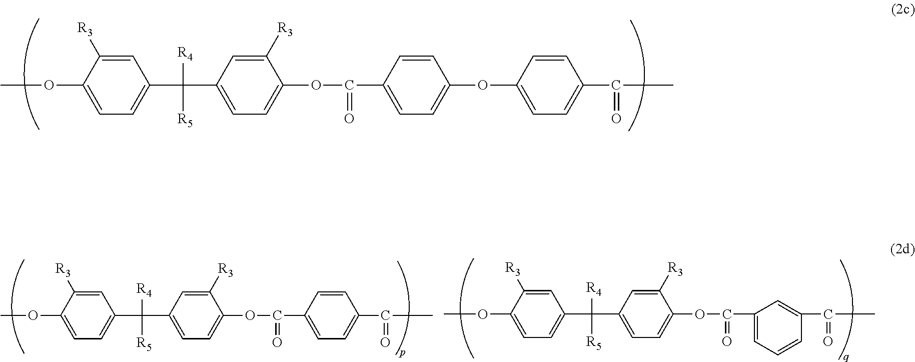

In Generic Formulae (2c) and (2d), R₃ represents a methyl group or a hydrogen atom, R₄ and R₅ each represent, independently of one another, a hydrogen atom or an alkyl group having one to four carbon atoms, and p and q represent numbers satisfying expressions p+q=1 and 0.1≦p≦0.9.

Resin-4 having a repeating unit shown below in Formula (2c-1) is provided as a specific example of the polyarylate resin having the repeating unit shown in Generic Formula (2c).

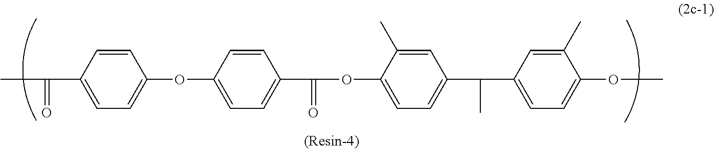

The charge transport layer 14 may further contain a different resin as a binder resin. Examples of different resins that can be used as the binder resin include thermoplastic resins (for example, other polycarbonate resins, polyester resins, polyarylate resins, styrene-butadiene copolymers, styrene-acrylonitrile copolymers, styrene-maleate copolymers, acrylic copolymers, styrene-acrylate copolymers, polyethylenes, ethylene-vinyl acetate copolymers, chlorinated polyethylenes, polyvinyl chlorides, polypropylenes, ionomers, vinyl chloride-vinyl acetate copolymers, alkyd resins, polyamides, polyurethanes, polysulfones, diallyl phthalate resins, ketone resins, polyvinyl butyral resins, and polyether resins), thermosetting resins (for example, silicone resins, epoxy resins, phenolic resins, urea resins, and melamine resins), and photocurable resins (for example, epoxy acrylates and urethane-acrylates). Note that the binder resins listed above may be used singly, or in a mixture or copolymer of two or more types. The charge transport layer 14 preferably has a film thickness of at least 5 μm and no greater than 50 μm.

Also, in the multi-layer electrophotographic photosensitive member 10, abrasion loss can be restricted through a ratio of the hole transport material relative to the binder resin in the charge transport layer 14 being no greater than 0.55.

The charge transport layer 14 may further contain an electron transport material in addition to the hole transport material. Examples of the electron transport material include quinone derivatives, anthraquinone derivatives, malononitrile derivatives, thiopyran derivatives, trinitrothioxanthone derivatives, 3,4,5,7-tetranitro-9-fluorenone derivatives, dinitroanthracene derivatives, dinitroacridine derivatives, nitroanthraquinone derivatives, dinitroanthraquinone derivatives, tetracyanoethylene, 2,4,8-trinitrothioxanthone, dinitrobenzene, dinitroanthracene, dinitroacridine, nitroanthraquinone, dinitroanthraquinone, succinic anhydride, maleic anhydride, and dibromomaleic anhydride. Note that the electron transport materials list above may be used singly or in a combination of two or more types. When the charge transport layer 14 contains an electron transport material such as listed above, the amount of the electron transport material is preferably at least 1 part by mass and no greater than 50 parts by mass relative to 100 parts by mass of the triarylamine derivative shown in Generic Formula (1). Note that even when an electron transport material is contained in the charge transport layer 14 of the multi-layer electrophotographic photosensitive member 10, the ratio of the hole transport material relative to the binder resin in the charge transport layer 14 is preferably no greater than 0.55. Through the above, abrasion loss can be restricted.

In addition to the hole transport material and the binder resin, the charge transport layer 14 may further contain a compound having a ketone structure or a dicyanomethylene structure as an electron acceptor compound. Charge transport in the charge transport layer 14 can be effectively improved through inclusion of the electron acceptor compound therein due to the electron acceptor compound supplementing the hole transport material.

The following provides examples of compounds having a ketone structure or a dicyanomethylene structure that are shown in Generic Formula (3).

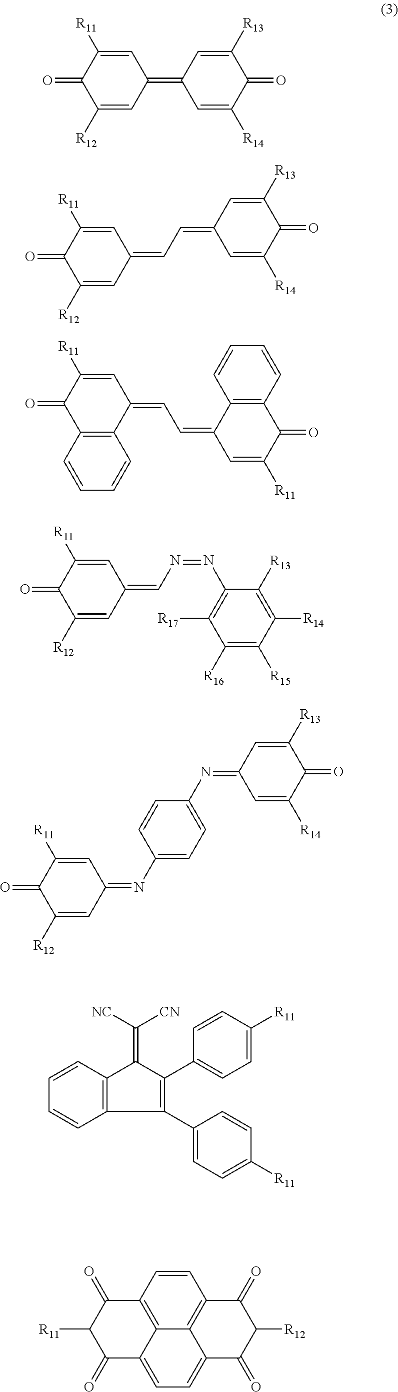

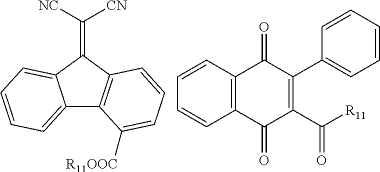

In Generic Formula (3), R₁₁, R₁₂, R₁₃, R₁₄, R₁₅, R₁₆, and R₁₇ each represent, independently of one another, a hydrogen atom, a halogen atom, a methyl group, an ethyl group, a propyl group, a butyl group, a pentyl group, a benzyloxy group, or a phenyl group optionally substituted with at least one substituent selected from the group consisting of a methyl group, an ethyl group, a propyl group, and a methyl alkoxy group.

In Generic Formula (3), R₁₁, R₁₂, R₁₃, R₁₄, R₁₅, R₁₆, and R₁₇ preferably each represent, independently of one another, a hydrogen atom, a halogen atom, a methyl group, a butyl group (for example, an n-butyl group or a tert-butyl group), a pentyl group (for example, a 1,1-dimethylpropyl group), a benzyloxy group, or a phenyl group optionally substituted with at least one substituent (for example, one or two substituents) selected from the group consisting of a methyl group and an ethyl group.

ETM-1 to ETM-11 shown below in Formulae (3-1) to (3-11) are provided as specific examples of the compounds having a ketone structure or a dicyanomethylene structure shown in Generic Formula (3), that can be used as the electron acceptor compound.

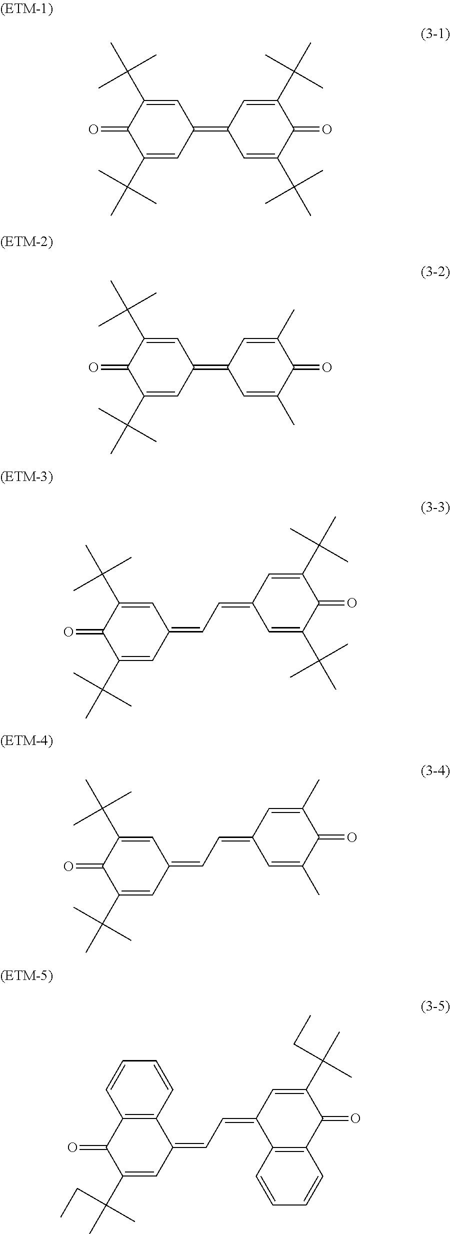 [SMILES: CC(C)(C)C1=CC(=C2C=C(C(C)(C)C)C(=O)C(C(C)(C)C)=C2)C=C(C(C)(C)C)C1=O ; CC1=CC(=C2C=C(C(C)(C)C)C(=O)C(C(C)(C)C)=C2)C=C(C)C1=O ; CC(C)(C)C1=CC(=CC=C2C=C(C(C)(C)C)C(=O)C(C(C)(C)C)=C2)C=C(C(C)(C)C)C1=O ; CC1=CC(=CC=C2C=C(C(C)(C)C)C(=O)C(C(C)(C)C)=C2)C=C(C)C1=O ; CCC(C)(C)C1=C/C(=C/C=C2/C=C(C(C)(C)CC)C(=O)c3ccccc32)c2ccccc2C1=O]

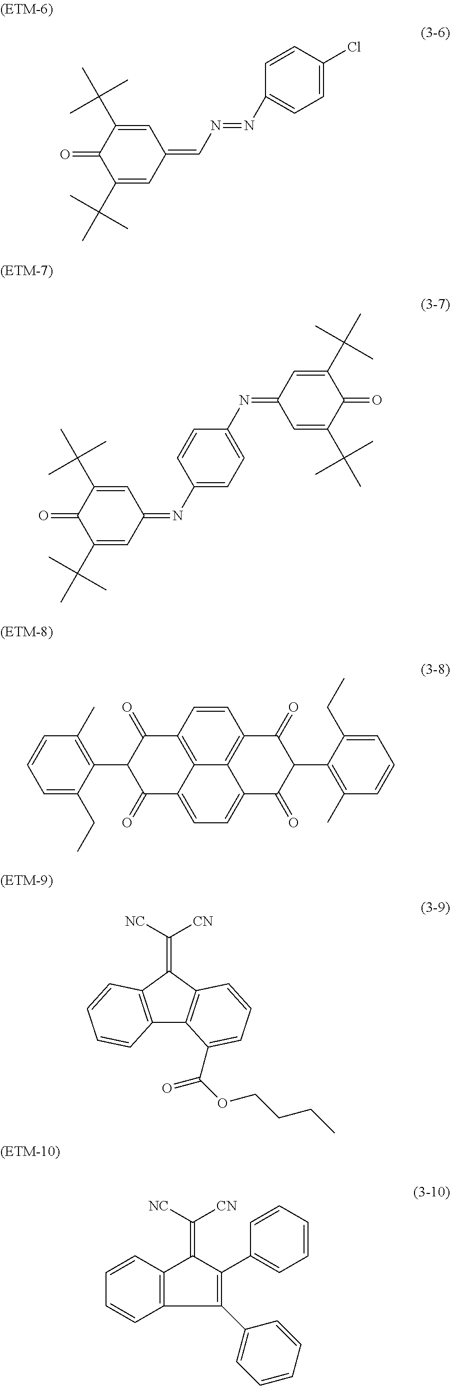 [SMILES: CC(C)(C)C1=CC(=C/N=N/c2ccc(Cl)cc2)C=C(C(C)(C)C)C1=O ; CC(C)(C)C1=CC(=Nc2ccc(N=C3C=C(C(C)(C)C)C(=O)C(C(C)(C)C)=C3)cc2)C=C(C(C)(C)C)C1=O ; CCc1cccc(C)c1C1C(=O)c2ccc3c4c(ccc(c24)C1=O)C(=O)C(c1c(C)cccc1CC)C3=O ; CCCCOC(=O)c1cccc2c1-c1ccccc1C2=C(C#N)C#N ; N#CC(C#N)=C1C(c2ccccc2)=C(c2ccccc2)c2ccccc21]

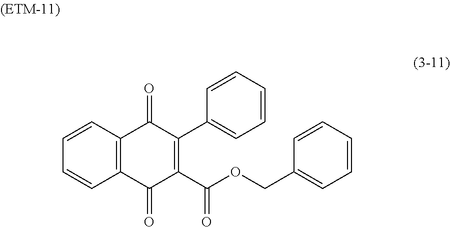 [SMILES: O=C(OCc1ccccc1)C1=C(c2ccccc2)C(=O)c2ccccc2C1=O]

[Method for Manufacturing Multi-Layer Electrophotographic Photosensitive Member 10]

The multi-layer electrophotographic photosensitive member 10 can for example be manufactured through the process described below. First, a charge generating material, a base resin, an additive, and the like, are mixed in a coating solvent (solvent for preparing an application liquid for a charge generating layer) to prepare an application liquid for a charge generating layer. The application liquid which is prepared is applied onto a conductive substrate (aluminum tube) by an application method such as dip coating, spray coating, bead coating, blade coating, or roller coating. Next, hot-air drying is for example performed for 40 minutes at 100° C. to form a charge generating layer 13 having a specified film thickness.

Various different organic coating solvents can be used as the coating solvent in preparation of the application liquid. Examples of the coating solvent include alcohols (for example, methanol, ethanol, isopropanol, and butanol), aliphatic hydrocarbons (for example, n-hexane, octane, and cyclohexane), aromatic hydrocarbons (for example, benzene, toluene, and xylene (preferably o-xylene), halogenated hydrocarbons (for example, dichloromethane, dichloroethane, chloroform, carbon tetrachloride, and chlorobenzene), ethers (for example, dimethyl ether, diethyl ether, tetrahydrofuran, ethylene glycol dimethyl ether, diethylene glycol dimethyl ether, 1,3-dioxolane, and 1,4-dioxane), ketones (for example, acetone, methyl ethyl ketone, and cyclohexanone), esters (for example, ethyl acetate and methyl acetate), dimethyl formaldehyde, dimethyl formamide, and dimethyl sulfoxide. Note that the coating solvents listed above may be used singly or in a mixture of two or more types.

Next, an application liquid for a charge transport layer is prepared by dispersing the triarylamine derivative shown in Generic Formula (1), the aforementioned binder resin, an additive, and the like, in a coating solvent (solvent for preparing an application liquid for a charge transport layer). Once the application liquid for the charge transport layer has been prepared, the application liquid is applied onto the charge generating layer 13, which has already been formed, and is dried thereon. Note that application liquid preparation, application, and drying can be performed by the same methods as used for forming the charge generating layer 13. The coating solvent (solvent for preparing the application liquid for the charge transport layer) can be any of the coating solvents listed above for preparation of the application liquid for the charge generating layer. Among the coating solvents listed above, at least one of tetrahydrofuran, toluene, 1,4-dioxane, and o-xylene is preferably used as the solvent (coating solvent) for preparing the charge transport layer 14. Using at least one of these four coating solvents enables improved dissolution of a hole transport material including the triarylamine derivative shown in Generic Formula (1). As a result, there is a greater tendency for the hole transport material to be uniformly distributed throughout the charge transport layer 14 which is obtained. Inclusion of the charge transport layer 14 described above in the multi-layer electrophotographic photosensitive member 10 enables further suppression of crystallization at the surface of the multi-layer electrophotographic photosensitive member 10.

Note that due to the electrophotographic photosensitive member 10 according to the present disclosure having a multi-layer structure, the triarylamine derivative shown in Generic Formula (1) can effectively exhibit excellent electrical characteristics as a hole transport material. In general, charge transport efficiency may be restricted in a multi-layer structure due to charge transfer being necessary at the interface between the charge generating layer and the charge transport layer. However, as a result of the triarylamine derivative shown in Generic Formula (1) being used as the hole transport material in the present disclosure, charge migration can occur stably at the interface between the charge generating layer and the charge transport layer due to the ionization potential being low.

### EXAMPLES

### Example 1

### 1. Manufacture of Multi-Layer Electrophotographic Photosensitive Member

(1) Intermediate Layer Formation

First, 2 parts by mass of titanium oxide (SMT-A manufactured by TAYCA CORPORATION, number average primary particle diameter 10 nm) and 1 part by mass of a four-component copolymer polyamide resin of polyamide 6, polyamide 12, polyamide 66, and polyamide 610 (Amilan® CM8000 manufactured by Toray Industries, Inc.) were mixed with, as a solvent, 10 parts by mass of methanol, 1 part by mass of butanol, and 1 part by mass of toluene, using a bead mill, thereby dispersing the above materials for five hours. Note that titanium oxide that after surface treatment with alumina and silica, had been surface treated using methyl hydrogen polysiloxane during wet dispersion, was used as the aforementioned titanium oxide. Next, filtration of the resulting mixture was performed using a five μm filter to prepare an application liquid for an intermediate layer.

The application liquid for the intermediate layer was subsequently applied onto a drum-shaped aluminum conductive substrate (supporting substrate) of 30 mm in diameter and 246 mm in length by submerging the aluminum conductive substrate in the application liquid at a rate of 5 mm/s with one end of the aluminum conductive substrate orientated in an upward direction. Next, curing treatment was performed for 30 minutes at 130° C., thereby forming an intermediate layer having a film thickness of 2 μm.

(2) Charge Generating Layer Formation

Next, 1.5 parts by mass of oxo-titanium phthalocyanine (CGM-1) shown in Formula (4) as a charge generating material and 1 part by mass of polyvinyl acetal resin (S-LEC BX-5 manufactured by Sekisui Chemical Co., Ltd.) as a base resin were mixed with, as a coating solvent, 40 parts by mass of propylene glycol monomethyl ether and 40 parts by mass of tetrahydrofuran, using a bead mill. The mixture was dispersed for two hours to obtain an application liquid for a charge generating layer. The application liquid obtained as described above was filtered using a three μm filter and was subsequently applied onto the aforementioned intermediate layer by dip coating. Next, the application liquid was dried for five minutes at 50° C., thereby forming a charge generating layer having a film thickness of 0.3 μm.

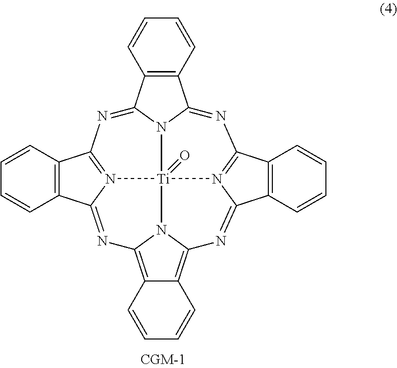

(3) Charge Transport Layer Formation

Next, 45 parts by mass of the triarylamine derivative (HTM-1) shown in Formula (1-1) as a hole transport material, 0.5 parts by mass of Irganox 1010 as an additive, 2 parts by mass of an electron acceptor compound (ETM-1) shown in Formula (3-1), and 100 parts by mass of the polycarbonate resin (Resin-1, viscosity average molecular weight 50,500) having the repeating unit shown in Formula (2a-1) as a binder resin, were added to an ultrasound disperser with, as a coating solvent, 490 parts by mass of tetrahydrofuran and 210 parts by mass of toluene. Once the contents of the ultrasound disperser had been mixed, dispersion treatment was performed on the contents for 10 minutes, thereby preparing an application liquid for a charge transport layer.

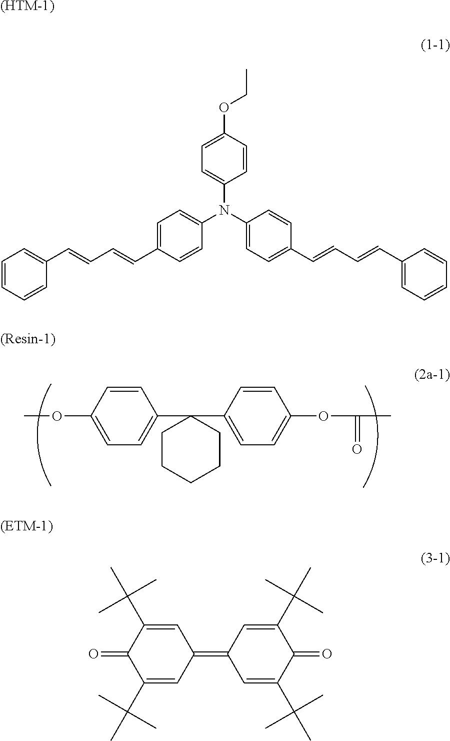

The application liquid for the charge transport layer, which was prepared as described above, was applied onto the charge generating layer in the same way as described for the application liquid for the charge generating layer. The application liquid for the charge transport layer was subsequently dried for 40 minutes at 120° C., thereby forming a charge transport layer having a film thickness of 20 μm. Through the process described above, the multi-layer electrophotographic photosensitive member was manufactured.

### 2. Evaluation

(1) Multi-Layer Electrophotographic Photosensitive Member Evaluation

<Electrical Characteristics Evaluation>

Chargeability (surface potential V₀) and sensitivity (potential V_{L} at 50 ms after light exposure) of the electrophotographic photosensitive member were measured under the following conditions at a temperature of 10° C. and a relative humidity of 20%, using an electrical characteristics tester manufactured by Gentec Inc. Results of the above measurements are shown in Table 1.

<Chargeability Measurement Conditions>

Rotation speed: 31 rpm

Electric current flowing into drum: −10 μA

<Sensitivity Measurement Conditions>

Charge amount: 600 V

Light exposure wavelength: 780 nm

Light exposure amount: 0.26 μJ/cm²

<Crystallization Evaluation>

Occurrence of crystallization was evaluated at the surface of the multi-layer electrophotographic photosensitive member that was manufactured. More specifically, evaluation was performed by checking for presence of crystals at the surface of the multi-layer electrophotographic photosensitive member using an optical microscope. Results of the above evaluation are shown in Table 1. Note that an evaluation of “Good” in Table 1 indicates that crystals were not observed.

<Abrasion Loss Evaluation>

The aforementioned application liquid for the charge transport layer was applied onto a polypropylene (PP) sheet (thickness 0.3 mm) wound around a ø 78 aluminum pipe. The application liquid was dried for 40 minutes at 120° C., thereby forming a sheet for abrasion loss evaluation having a film thickness of 30 nm. A sample was prepared by removing the charge transport layer (CT layer) from the PP sheet and mounting the charge transport layer on a round mounting sheet S-36 (manufactured by TABER Industries). A 1,000 rotation abrasion test was performed on the prepared sample by a rotary abrasion tester (manufactured by Toyo Seiki Co., Ltd.), using an abrasion wheel C-10 (manufactured by TABER Industries), a 500 gf load, and a rotation speed of 60 rpm. The abrasion loss (mg/1000 rotations) was measured as a difference between the mass of the sample prior to the abrasion test and the mass of the sample after the abrasion test. Abrasion resistance was evaluated based on the abrasion loss which was measured.

Table 1 shows results of the electrical characteristics evaluation, the crystallinity evaluation, and the abrasion loss evaluation for the multi-layer electrophotographic photosensitive member described above. Table 1 also shows each of the materials used in preparation of the multi-layer electrophotographic photosensitive member.

### Example 2

In Example 2, HTM-2 shown in Formula (1-2) was used as a hole transport material instead of HTM-1, but in all other aspects a multi-layer electrophotographic photosensitive member was manufactured and evaluated in the same way as in Example 1. Results obtained for Example 2 are shown in Table 1.

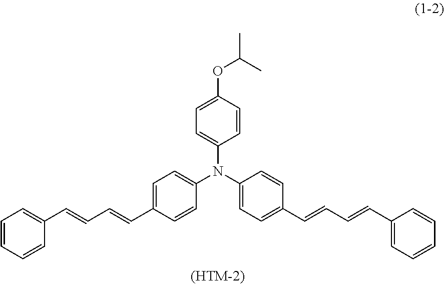

### Example 3

In Example 3, HTM-3 shown in Formula (1-3) was used as a hole transport material instead of HTM-1, but in all other aspects a multi-layer electrophotographic photosensitive member was manufactured and evaluated in the same way as in Example 1. Results obtained for Example 3 are shown in Table 1.

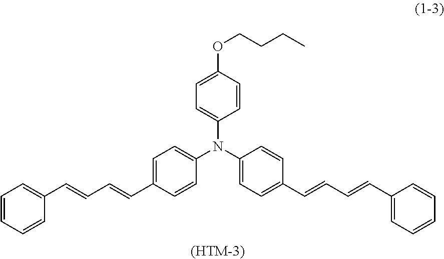

### Example 4

In Example 4, HTM-4 shown in Formula (1-4) was used as a hole transport material instead of HTM-1, but in all other aspects a multi-layer electrophotographic photosensitive member was manufactured and evaluated in the same way as in Example 1. Results obtained for Example 4 are shown in Table 1.

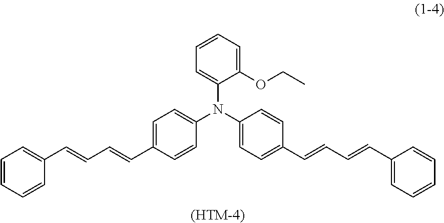

### Example 5

In Example 5, HTM-5 shown in Formula (1-5) was used as a hole transport material instead of HTM-1, but in all other aspects a multi-layer electrophotographic photosensitive member was manufactured and evaluated in the same way as in Example 1. Results obtained for Example 5 are shown in Table 1.

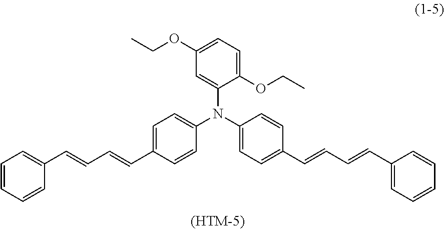

### Example 6

In Example 6, HTM-6 shown in Formula (1-6) was used as a hole transport material instead of HTM-1, but in all other aspects a multi-layer electrophotographic photosensitive member was manufactured and evaluated in the same way as in Example 1. Results obtained for Example 6 are shown in Table 1.

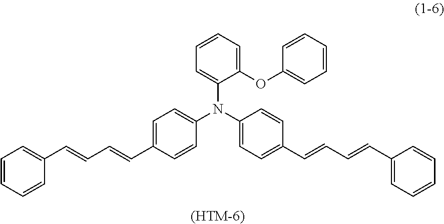

### Example 7

In Example 7, HTM-7 shown in Formula (1-7) was used as a hole transport material instead of HTM-1, but in all other aspects a multi-layer electrophotographic photosensitive member was manufactured and evaluated in the same way as in Example 1. Results obtained for Example 7 are shown in Table 1.

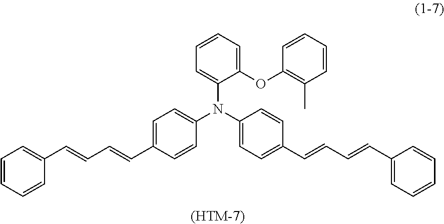

### Example 8

In Example 8, HTM-8 shown in Formula (1-8) was used as a hole transport material instead of HTM-1, but in all other aspects a multi-layer electrophotographic photosensitive member was manufactured and evaluated in the same way as in Example 1. Results obtained for Example 8 are shown in Table 1.

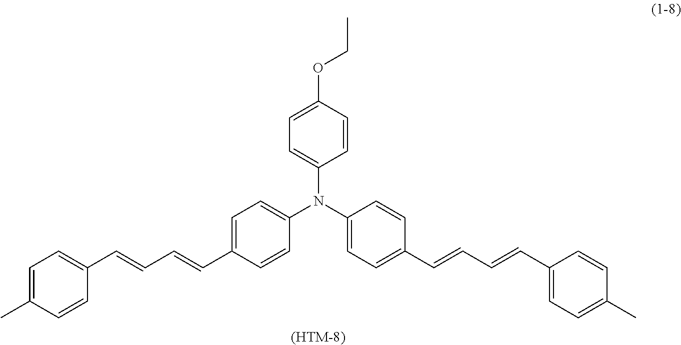

### Example 9

In Example 9, HTM-9 shown in Formula (1-9) was used as a hole transport material instead of HTM-1, but in all other aspects a multi-layer electrophotographic photosensitive member was manufactured and evaluated in the same way as in Example 1. Results obtained for Example 9 are shown in Table 1.

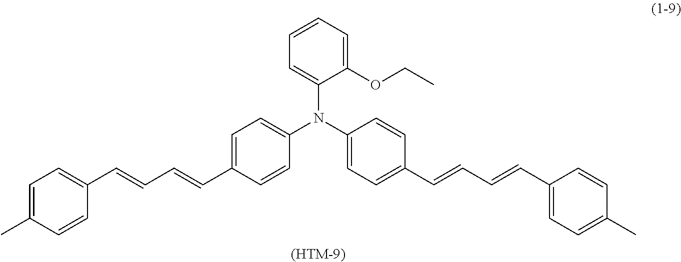

### Example 10

In Example 10, Resin-2 (viscosity average molecular weight 50,500) having the repeating unit shown in Formula (2a-2) was used as a binder resin instead of Resin-1, but in all other aspects a multi-layer electrophotographic photosensitive member was manufactured and evaluated in the same way as in Example 4. Results obtained for Example 10 are shown in Table 1.

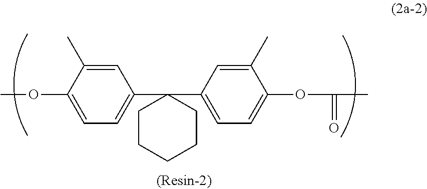

### Example 11

In Example 11, Resin-3 (viscosity average molecular weight 50,500) having the repeating unit shown in Formula (2b-1) was used as a binder resin instead of Resin-1, but in all other aspects a multi-layer electrophotographic photosensitive member was manufactured and evaluated in the same way as in Example 4. Results obtained for Example 11 are shown in Table 1.

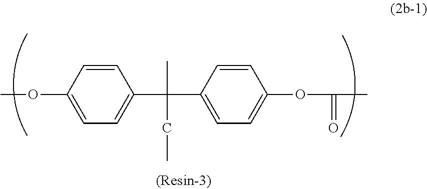

### Example 12

In Example 12, Resin-4 (viscosity average molecular weight 50,500) having the repeating unit shown in Formula (2c-1) was used as a binder resin instead of Resin-1, but in all other aspects a multi-layer electrophotographic photosensitive member was manufactured and evaluated in the same way as in Example 4. Results obtained for Example 12 are shown in Table 1.

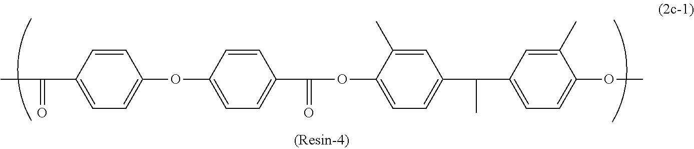

### Example 13

In Example 13, ETM-2 shown in Formula (3-2) was used as an electron acceptor compound instead of ETM-1, but in all other aspects a multi-layer electrophotographic photosensitive member was manufactured and evaluated in the same way as in Example 4. Results obtained for Example 13 are shown in Table 1.

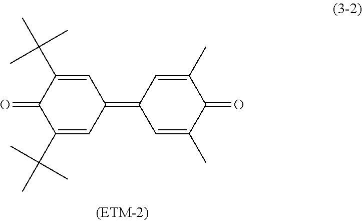 [SMILES: CC1=CC(=C2C=C(C(C)(C)C)C(=O)C(C(C)(C)C)=C2)C=C(C)C1=O]

### Example 14

In Example 14, ETM-3 shown in Formula (3-3) was used as an electron acceptor compound instead of ETM-1, but in all other aspects a multi-layer electrophotographic photosensitive member was manufactured and evaluated in the same way as in Example 4. Results obtained for Example 14 are shown in Table 1.

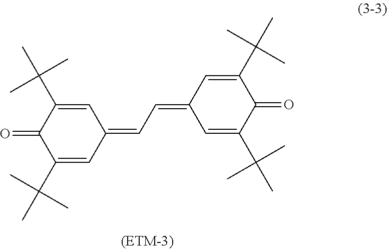 [SMILES: CC(C)(C)C1=CC(=CC=C2C=C(C(C)(C)C)C(=O)C(C(C)(C)C)=C2)C=C(C(C)(C)C)C1=O]

### Example 15

In Example 15, ETM-4 shown in Formula (3-4) was used as an electron acceptor compound instead of ETM-1, but in all other aspects a multi-layer electrophotographic photosensitive member was manufactured and evaluated in the same way as in Example 4. Results obtained for Example 15 are shown in Table 1.

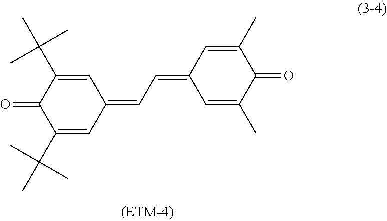 [SMILES: CC1=CC(=CC=C2C=C(C(C)(C)C)C(=O)C(C(C)(C)C)=C2)C=C(C)C1=O]

### Example 16

In Example 16, ETM-5 shown in Formula (3-5) was used as an electron acceptor compound instead of ETM-1, but in all other aspects a multi-layer electrophotographic photosensitive member was manufactured and evaluated in the same way as in Example 4. Results obtained for Example 16 are shown in Table 1.

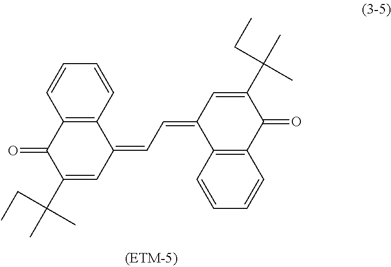 [SMILES: CCC(C)(C)C1=C/C(=C/C=C2/C=C(C(C)(C)CC)C(=O)c3ccccc32)c2ccccc2C1=O]

### Example 17

In Example 17, ETM-6 shown in Formula (3-6) was used as an electron acceptor compound instead of ETM-1, but in all other aspects a multi-layer electrophotographic photosensitive member was manufactured and evaluated in the same way as in Example 4. Results obtained for Example 17 are shown in Table 1.

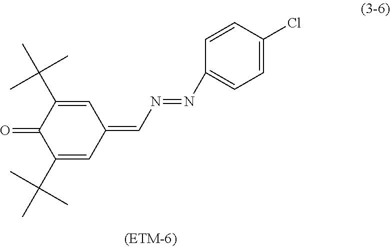 [SMILES: CC(C)(C)C1=CC(=C/N=N/c2ccc(Cl)cc2)C=C(C(C)(C)C)C1=O]

### Example 18

In Example 18, ETM-7 shown in Formula (3-7) was used as an electron acceptor compound instead of ETM-1, but in all other aspects a multi-layer electrophotographic photosensitive member was manufactured and evaluated in the same way as in Example 4. Results obtained for Example 18 are shown in Table 1.

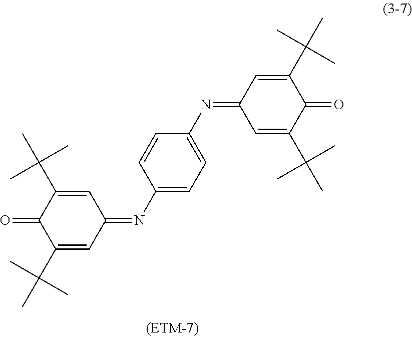 [SMILES: CC(C)(C)C1=CC(=Nc2ccc(N=C3C=C(C(C)(C)C)C(=O)C(C(C)(C)C)=C3)cc2)C=C(C(C)(C)C)C1=O]

### Example 19

In Example 19, ETM-8 shown in Formula (3-8) was used as an electron acceptor compound instead of ETM-1, but in all other aspects a multi-layer electrophotographic photosensitive member was manufactured and evaluated in the same way as in Example 4. Results obtained for Example 19 are shown in Table 1.

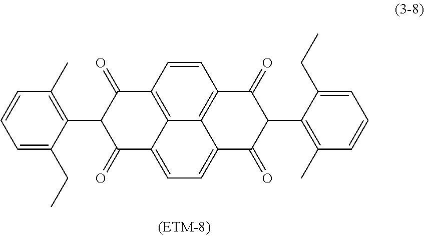 [SMILES: CCc1cccc(C)c1C1C(=O)c2ccc3c4c(ccc(c24)C1=O)C(=O)C(c1c(C)cccc1CC)C3=O]

### Example 20

In Example 20, ETM-9 shown in Formula (3-9) was used as an electron acceptor compound instead of ETM-1, but in all other aspects a multi-layer electrophotographic photosensitive member was manufactured and evaluated in the same way as in Example 4. Results obtained for Example 20 are shown in Table 1.

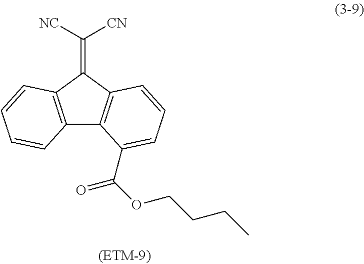 [SMILES: CCCCOC(=O)c1cccc2c1-c1ccccc1C2=C(C#N)C#N]

### Example 21

In Example 21, ETM-10 shown in Formula (3-10) was used as an electron acceptor compound instead of ETM-1, but in all other aspects a multi-layer electrophotographic photosensitive member was manufactured and evaluated in the same way as in Example 4. Results obtained for Example 21 are shown in Table 1.

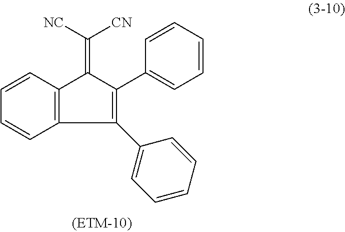 [SMILES: N#CC(C#N)=C1C(c2ccccc2)=C(c2ccccc2)c2ccccc21]

### Example 22

In Example 22, ETM-11 shown in Formula (3-11) was used as an electron acceptor compound instead of ETM-1, but in all other aspects a multi-layer electrophotographic photosensitive member was manufactured and evaluated in the same way as in Example 4. Results obtained for Example 22 are shown in Table 1.

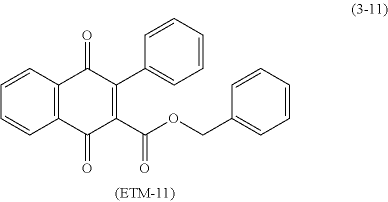 [SMILES: O=C(OCc1ccccc1)C1=C(c2ccccc2)C(=O)c2ccccc2C1=O]

### Example 23

In Example 23, the ratio of the hole transport material relative to the binder resin was changed to 0.55, but in all other aspects a multi-layer electrophotographic photosensitive member was manufactured and evaluated in the same way as in Example 1. Results obtained for Example 23 are shown in Table 1.

### Example 24

In Example 24, the ratio of the hole transport material relative to the binder resin was changed to 0.35, but in all other aspects a multi-layer electrophotographic photosensitive member was manufactured and evaluated in the same way as in Example 1. Results obtained for Example 24 are shown in Table 1.

### Example 25

In Example 25, the ratio of the hole transport material relative to the binder resin was changed to 0.25, but in all other aspects a multi-layer electrophotographic photosensitive member was manufactured and evaluated in the same way as in Example 1. Results obtained for Example 25 are shown in Table 1.

### Example 26

In Example 26, the electron acceptor compound was omitted, but in all other aspects a multi-layer electrophotographic photosensitive member was manufactured and evaluated in the same way as in Example 1. Results obtained for Example 26 are shown in Table 1.

### Comparative Example 1

In Comparative Example 1, HTM-10 shown in Formula (11-1) was used as a hole transport material instead of HTM-1, but in all other aspects a multi-layer electrophotographic photosensitive member was manufactured and evaluated in the same way as in Example 1. Results obtained for Comparative Example 1 are shown in Table 1.

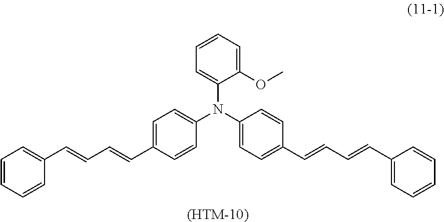

### Comparative Example 2

In Comparative Example 2, HTM-11 shown in Formula (11-2) was used as a hole transport material instead of HTM-10, but in all other aspects a multi-layer electrophotographic photosensitive member was manufactured and evaluated in the same way as in Comparative Example 1. Results obtained for Comparative Example 2 are shown in Table 1.

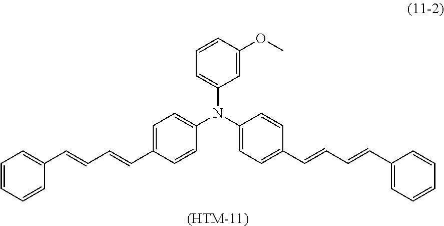

### Comparative Example 3

In Comparative Example 3, HTM-12 shown in Formula (11-3) was used as a hole transport material instead of HTM-10, but in all other aspects a multi-layer electrophotographic photosensitive member was manufactured and evaluated in the same way as in Comparative Example 1. Results obtained for Comparative Example 3 are shown in Table 1.

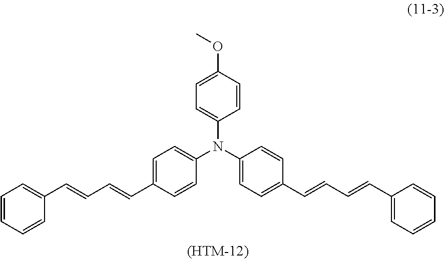

### Comparative Example 4

In Comparative Example 4, HTM-13 shown in Formula (11-4) was used as a hole transport material instead of HTM-10, but in all other aspects a multi-layer electrophotographic photosensitive member was manufactured and evaluated in the same way as in Comparative Example 1. Results obtained for Comparative Example 4 are shown in Table 1.

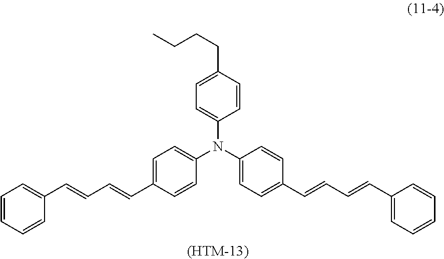

### Comparative Example 5

In Comparative Example 5, HTM-14 shown in Formula (11-5) was used as a hole transport material instead of HTM-10, but in all other aspects a multi-layer electrophotographic photosensitive member was manufactured and evaluated in the same way as in Comparative Example 1. Results obtained for Comparative Example 5 are shown in Table 1.

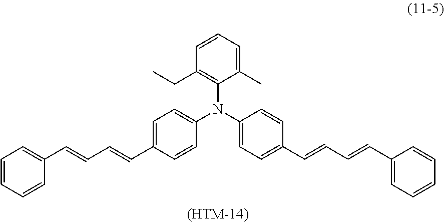

### Comparative Example 6

In Comparative Example 6, HTM-15 shown in Formula (11-6) was used as a hole transport material instead of HTM-10, but in all other aspects a multi-layer electrophotographic photosensitive member was manufactured and evaluated in the same way as in Comparative Example 1. Results obtained for Comparative Example 6 are shown in Table 1.

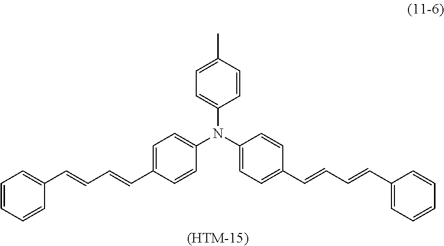

### Comparative Example 7

In Comparative Example 7, HTM-16 shown in Formula (11-7) was used as a hole transport material instead of HTM-10, but in all other aspects a multi-layer electrophotographic photosensitive member was manufactured and evaluated in the same way as in Comparative Example 1. Results obtained for Comparative Example 7 are shown in Table 1.

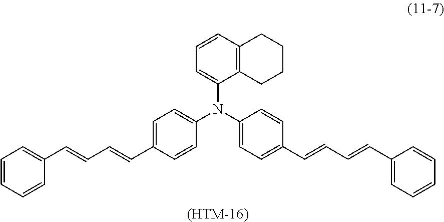

### Comparative Example 8

In Comparative Example 8, the ratio of the hole transport material relative to the binder resin was changed to 0.65, but in all other aspects a multi-layer electrophotographic photosensitive member was manufactured and evaluated in the same way as in Example 1. Results obtained for Comparative Example 8 are shown in Table 1.

### Comparative Example 9

In Comparative Example 9, the ratio of the hole transport material relative to the binder resin was changed to 0.80, but in all other aspects a multi-layer electrophotographic photosensitive member was manufactured and evaluated in the same way as in Example 1. Results obtained for Comparative Example 9 are shown in Table 1.

Note that in Table 1, “CTL” indicates the charge transport layer, HTM indicates the charge transport material, “Resin” indicates the binder resin, and “ETM” indicates the electron acceptor compound.

TABLE 1

| | | | | | | | | | Abrasion |
|---|---|---|---|---|---|---|---|---|---|
| | CTL | | | | | Electrical | | | loss per |
| | | | | HTM/resin | | characteristics | | Drum | 1,000 |
| | HTM | Resin | ETM | ratio | Coating solvent | V₀/V | V_{L}/V | appearance | rotations |
| Example 1 | HTM-1 | Resin-1 | ETM-1 | 0.45 | 7:3 THF/toluene | 710 | 52 | Good | 7.0 mg |
| Example 2 | HTM-2 | Resin-1 | ETM-1 | 0.45 | 7:3 THF/toluene | 658 | 55 | Good | 6.8 mg |
| Example 3 | HTM-3 | Resin-1 | ETM-1 | 0.45 | 7:3 THF/toluene | 700 | 56 | Good | 6.8 mg |
| Example 4 | HTM-4 | Resin-1 | ETM-1 | 0.45 | 7:3 THF/toluene | 704 | 53 | Good | 6.9 mg |
| Example 5 | HTM-5 | Resin-1 | ETM-1 | 0.45 | 7:3 THF/toluene | 693 | 55 | Good | 7.3 mg |
| Example 6 | HTM-6 | Resin-1 | ETM-1 | 0.45 | 7:3 THF/toluene | 688 | 59 | Good | 7.5 mg |
| Example 7 | HTM-7 | Resin-1 | ETM-1 | 0.45 | 7:3 THF/toluene | 702 | 60 | Good | 7.2 mg |
| Example 8 | HTM-8 | Resin-1 | ETM-1 | 0.45 | 7:3 THF/toluene | 699 | 48 | Good | 6.4 mg |
| Example 9 | HTM-9 | Resin-1 | ETM-1 | 0.45 | 7:3 THF/toluene | 698 | 47 | Good | 7.2 mg |
| Example 10 | HTM-4 | Resin-2 | ETM-1 | 0.45 | 7:3 THF/toluene | 721 | 55 | Good | 6.9 mg |
| Example 11 | HTM-4 | Resin-3 | ETM-1 | 0.45 | 7:3 THF/toluene | 702 | 55 | Good | 6.5 mg |
| Example 12 | HTM-4 | Resin-4 | ETM-1 | 0.45 | 7:3 THF/toluene | 682 | 72 | Good | 7.6 mg |
| Example 13 | HTM-4 | Resin-1 | ETM-2 | 0.45 | 7:3 THF/toluene | 703 | 59 | Good | 7.5 mg |
| Example 14 | HTM-4 | Resin-1 | ETM-3 | 0.45 | 7:3 THF/toluene | 700 | 52 | Good | 7.4 mg |
| Example 15 | HTM-4 | Resin-1 | ETM-4 | 0.45 | 7:3 THF/toluene | 702 | 59 | Good | 7.0 mg |
| Example 16 | HTM-4 | Resin-1 | ETM-5 | 0.45 | 7:3 THF/toluene | 687 | 60 | Good | 7.4 mg |
| Example 17 | HTM-4 | Resin-1 | ETM-6 | 0.45 | 7:3 THF/toluene | 699 | 60 | Good | 6.5 mg |
| Example 18 | HTM-4 | Resin-1 | ETM-7 | 0.45 | 7:3 THF/toluene | 701 | 58 | Good | 6.7 mg |
| Example 19 | HTM-4 | Resin-1 | ETM-8 | 0.45 | 7:3 THF/toluene | 703 | 58 | Good | 6.8 mg |
| Example 20 | HTM-4 | Resin-1 | ETM-9 | 0.45 | 7:3 THF/toluene | 700 | 57 | Good | 7.5 mg |
| Example 21 | HTM-4 | Resin-1 | ETM-10 | 0.45 | 7:3 THF/toluene | 700 | 57 | Good | 7.4 mg |
| Example 22 | HTM-4 | Resin-1 | ETM-11 | 0.45 | 7:3 THF/toluene | 678 | 60 | Good | 7.1 mg |
| Example 23 | HTM-1 | Resin-1 | ETM-1 | 0.55 | 7:3 THF/toluene | 729 | 50 | Good | 7.8 mg |
| Example 24 | HTM-1 | Resin-1 | ETM-1 | 0.35 | 7:3 THF/toluene | 701 | 69 | Good | 4.7 mg |
| Example 25 | HTM-1 | Resin-1 | ETM-1 | 0.25 | 7:3 THF/toluene | 678 | 75 | Good | 3.6 mg |
| Example 26 | HTM-1 | Resin-1 | — | 0.45 | 7:3 THF/toluene | 701 | 76 | Good | 7.3 mg |
| Comparative | HTM-10 | Resin-1 | ETM-1 | 0.45 | 7:3 THF/toluene | 702 | 252 | Crystallized | — |
| Example 1 | | | | | | | | | |
| Comparative | HTM-11 | Resin-1 | ETM-1 | 0.45 | 7:3 THF/toluene | 705 | 235 | Crystallized | — |
| Example 2 | | | | | | | | | |
| Comparative | HTM-12 | Resin-1 | ETM-1 | 0.45 | 7:3 THF/toluene | 689 | 270 | Crystallized | — |
| Example 3 | | | | | | | | | |
| Comparative | HTM-13 | Resin-1 | ETM-1 | 0.45 | 7:3 THF/toluene | 699 | 70 | Slightly | 7.6 mg |
| Example 4 | | | | | | | | crystallized | |
| Comparative | HTM-14 | Resin-1 | ETM-1 | 0.45 | 7:3 THF/toluene | 700 | 65 | Slightly | 8.0 mg |
| Example 5 | | | | | | | | crystallized | |
| Comparative | HTM-15 | Resin-1 | ETM-1 | 0.45 | 7:3 THF/toluene | 682 | 290 | Heavily | — |
| Example 6 | | | | | | | | crystallized | |
| Comparative | HTM-16 | Resin-1 | ETM-1 | 0.45 | 7:3 THF/toluene | 693 | 81 | Good | 6.9 mg |
| Example 7 | | | | | | | | | |
| Comparative | HTM-1 | Resin-1 | ETM-1 | 0.65 | 7:3 THF/toluene | 699 | 49 | Good | 9.2 mg |
| Example 8 | | | | | | | | | |
| Comparative | HTM-1 | Resin-1 | ETM-1 | 0.80 | 7:3 THF/toluene | 700 | 45 | Good | 11.4 mg |
| Example 9 | | | | | | | | | |

In a multi-layer electrophotographic photosensitive member according to the present disclosure, a specified oxo-titanium phthalocyanine is used as a charge generating material and a specified triarylamine derivative is used as a hole transport material. As a consequence, crystallization at the surface of the photosensitive member can be restricted, and excellent charge generation efficiency and electrical characteristics can be achieved, as shown in Table 1. According to the present disclosure, abrasion loss can be restricted through the ratio of the hole transport material relative to the binder resin being no greater than 0.55.

What is claimed is:

1. A multi-layer electrophotographic photosensitive member comprising
a photosensitive layer, wherein
the photosensitive layer includes, as sub-layers thereof:
a charge generating layer containing a charge generating material; and
a charge transport layer containing a hole transport material and a binder resin,
the charge generating material includes oxo-titanium phthalocyanine that among diffraction peaks for Bragg angles 2θ±0.2° with respect to characteristic X-rays of CuKα having a wavelength of 1.542 Å, at least exhibits a highest diffraction peak at 27.2°,
in the charge transport layer, a ratio of the hole transport material relative to the binder resin is no greater than 0.55, and
the hole transport material includes a triarylamine derivative shown in Generic Formula (1), 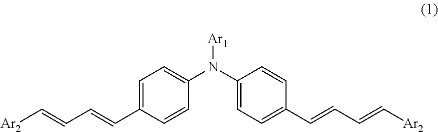
where, in the Generic Formula (1):
Ar₁ represents an aryl group substituted with at least one substituent selected from the group consisting of an alkoxy group having two to four carbon atoms and an optionally substituted phenoxy group; and
Ar₂ represents an aryl group optionally substituted with an alkyl group having one to four carbon atoms.

2. A multi-layer electrophotographic photosensitive member according to claim 1, wherein
at least one of tetrahydrofuran, toluene, 1,4-dioxane, and o-xylene is used as a coating solvent of the charge transport layer.

3. A multi-layer electrophotographic photosensitive member according to claim 1, wherein
the binder resin includes at least one of a polycarbonate resin having a repeating unit shown in Generic Formula (2a) and a polycarbonate resin having a repeating unit shown in Generic Formula (2b), 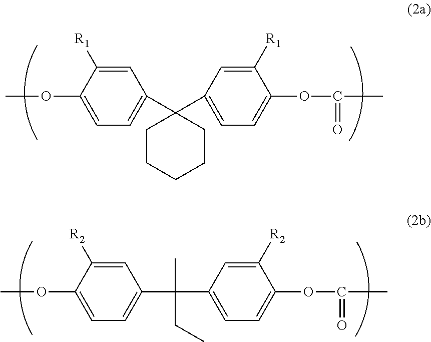
where R₁ in the Generic Formula (2a) represents a methyl group or a hydrogen atom, and
R₂ in the Generic Formula (2b) represents a methyl group or a hydrogen atom.

4. A multi-layer electrophotographic photosensitive member according to claim 1, wherein
the binder resin includes at least one of a polyarylate resin having a repeating unit shown in Generic Formula (2c) and a polyarylate resin having repeating units shown in Generic Formula (2d), 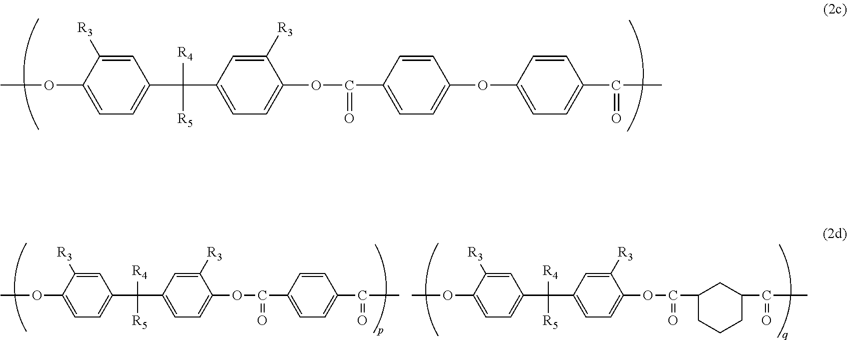
where, in the Generic Formulae (2c) and (2d):
R₃ represents a methyl group or a hydrogen atom;
R₄ and R₅ each represent, independently of one another, a hydrogen atom or an alkyl group having one to four carbon atoms; and
p and q represent numbers satisfying p+q=1 and 0.1≦p≦0.9.

5. A multi-layer electrophotographic photosensitive member according to claim 1, wherein
the charge transport layer further contains a compound having a ketone structure or a dicyanomethylene structure.

6. A multi-layer electrophotographic photosensitive member according to claim 5, wherein
the compound having the ketone structure or the dicyanomethylene structure is any one of compounds shown in Generic Formula (3), 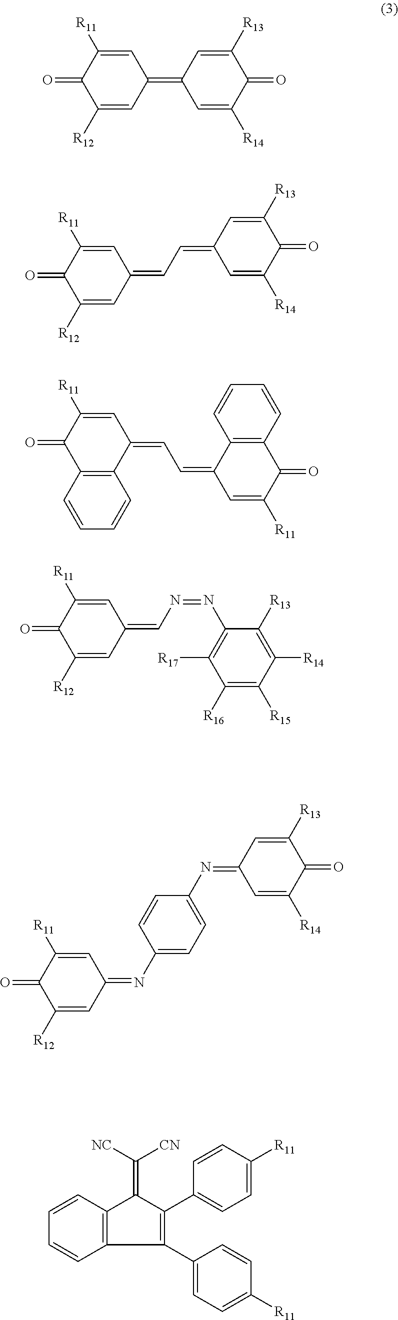 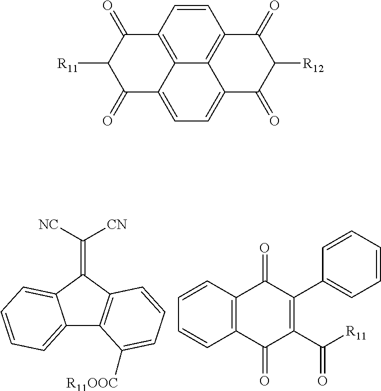
where, in Generic Formula (3), R₁₁, R₁₂, R₁₃, R₁₄, R₁₅, R₁₆, and R₁₇ each represent, independently of one another, a hydrogen atom, a halogen atom, a methyl group, an ethyl group, a propyl group, a butyl group, a pentyl group, a benzyloxy group, or a phenyl group optionally substituted with at least one substituent selected from the group consisting of a methyl group, an ethyl group, a propyl group, and a methyl alkoxy group.
